(19) United States
(12) Patent Application Publication
(10) Pub. No.: US 2018/0137457 A1
(43) Pub. Date: May 17, 2018

(54) MONITORING INVENTORY BASED ON IOT DEVICE DATA

(71) Applicant: SAP SE, Walldorf (DE)

(72) Inventors: Marco Sachs, Sankt Leon-Rot (DE); Nadim Razvi, Speyer (DE)

(21) Appl. No.: 15/353,677

(22) Filed: Nov. 16, 2016

(51) Int. Cl. G06Q 10/08; G06Q 30/06; G06Q 30/02; G06Q 20/04; H04L 29/08

(52) U.S. Cl. CPC G06Q 10/087; G06Q 30/0633; H04L 67/12; G06Q 20/0453; G06Q 30/0277

(57) ABSTRACT

A system for monitoring inventory based on Internet of things (IoT) devices is provided. In some implementations, the system performs operations comprising receiving, from at least one IoT device, a first indication that a first item has entered a predefined location, the first indication comprising an identification of the first item and an identification of the predefined location, and/or updating a current inventory for a household by adding the first item to the current inventory and marking the first item as being in stock. The operations can further include receiving, from the at least one IoT device, a second indication that the first item has exited the predefined location, and/or updating the current inventory by marking the first item as being in use based on the identification of the first item and the identification of the predefined location. Related systems, methods, and articles of manufacture are also described.

### FIELD

The subject matter disclosed herein relates to methods and apparatus for, among other things monitoring inventory based on Internet of things (IoT) devices.

### BACKGROUND

At times, managing a household can be as challenging and complicated as running an enterprise. A typical household can require the coordination/planning of several people and/or the execution of monetary transactions and physical actions within a given timeframes. As the world becomes more complex, daily tasks in our private lives can become even more complicated and/or demand more time and energy from the household. Notably, it can be challenging for a private household to keep track of all of their household purchases (e.g., groceries, appliances, toiletries, household supplies, consumer goods, and/or the like). For example, groceries are often purchased, put away, taken out, consumed, and/or thrown away on a daily basis, but tracking all of this information can be cumbersome.

Additionally, households are often flooded with advertisements and/or offers for groceries or other consumer goods, which can be difficult to monitor/organize to meet the current needs of a given household. Further, existing check-out processes in many brick and mortar stores (e.g., grocery stores, departments stores, etc.) can be time-consuming (e.g., waiting in line and checking out with a cashier or self-checkout terminal) and/or produce a lot of waste (e.g., printed paper receipts). Therefore, it may be desirable to provide systems and/or methods for monitoring household inventory and/or automatically generating promotional data.

### SUMMARY

In one aspect, a method, computer program product and system are provided. The method, computer program product and system execute operations for monitoring inventory based on Internet of things (IoT) devices. In one variation, the operations can include receiving, from at least one Internet of things (IoT) device, a first indication that a first item has entered a predefined location, the first indication comprising an identification of the first item and an identification of the predefined location. The operations can further include updating a current inventory for a household by adding the first item to the current inventory and marking the first item as being in stock, wherein the current inventory includes information on a plurality of items. The operations can further include receiving, from the at least one IoT device, a second indication that the first item has exited the predefined location, the second indication comprising the identification of the first item and the identification of the predefined location. The operations can further include updating the current inventory by marking the first item as being in use based on the identification of the first item and the identification of the predefined location. One or more of the operations can occur at or by a database server.

In various implementations, the operations can additionally or alternatively include receiving, from at least another IoT device, a third indication that the first item has entered a second predefined location, the third indication comprising the identification of the first item and an identification of the second predefined location, and/or updating the current inventory by removing the first item from the current inventory based on the identification of the first item and the identification of the second predefined location. In some aspects, the predefined location comprises at least one of a refrigerator, a freezer, a cabinet, and a shelf, and/or the second predefined location comprises at least one of a trash receptacle or a recycling receptacle. In related implementations, an apparatus causing the operations can comprise a user access device and/or a computing system configured to communicate over a wireless network with the at least one IoT device and the at least another IoT device. In some aspects, the at least one IoT device and the at least another IoT device each comprise a device with a plurality of sensors for identifying items. In some implementations, the at least one IoT device and the at least another IoT device are each configured to utilize a sleep state outside of active communications.

In some implementations, the operations can additionally or alternatively include generating historical data for at least a portion of the plurality of items, the historical data including an average time that the at least the portion of the plurality of items are in stock within the household. The operations can further include determining, based on the historical data, an expected time at which the first item will not be in stock, and/or providing an indication of the expected time to a user (e.g., for display or notification). In some implementations, the operations can additionally or alternatively include receiving electronic advertisement information and/or identifying, based on the current inventory, one or more sales and/or one or more coupons from the electronic advertisement information.

In some variations, the operations can additionally or alternatively include generating, based on the current inventory and the one or more sales or coupons, a shopping list for the household, and/or transmitting, via at least one wireless connection, the shopping list to a user access device registered for the household. In some aspects, the operations can include receiving an electronic receipt for a purchase made by a member of the household and/or updating the current inventory based on the electronic receipt, wherein the electronic receipt comprises indications of purchased items and quantities of the purchased items. In some implementations, an apparatus causing the operations can comprise another IoT device including a plurality of sensors for identifying items, wherein the at least one IoT device includes a plurality of sensors for identifying items, and wherein the at least one IoT device and the another IoT device are in a blockchain configuration with each other.

Implementations of the current subject matter can include, but are not limited to, systems and methods consistent with the present description, including one or more features as described, as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### BRIEF DESCRIPTION OF THE DRAWINGS

FIG. 1 illustrates a functional block diagram of a system in which features consistent with the described subject matter may be implemented;

FIG. 2 illustrates another functional block diagram of some of the components of the system of FIG. 1, in accordance with some example implementations;

FIG. 3 illustrates a functional block diagram of the computing system of FIG. 1 in communication with a plurality of Internet of things (IoT) devices, in accordance with some example implementations;

FIG. 4 illustrates an example implementation of the computing system and the plurality of IoT devices of FIG. 3;

FIG. 5 illustrates a functional block diagram of a computing apparatus for implementing features consistent with the described subject matter, in accordance with some example implementations; and

FIG. 6 illustrates a flowchart of a method for monitoring inventory and/or automatically generating promotional data, in accordance with some example implementations.

Where practical, like labels are used to refer to the same or similar items in the figures.

### DETAILED DESCRIPTION

As noted above, managing household purchases (e.g., groceries, appliances, toiletries, household supplies, consumer goods, and/or the like) can be complicated, existing check-out processes can be wasteful, and tracking available promotional offers with respect to current household demands can be difficult. For example, it is difficult to manually track the status and/or quantity of consumer goods without expending a lot of time and effort. Further, although the information contained on a receipt can be read by humans, the information is generally not available in an electronic and/or machine readable format, further complicating these tasks. Additionally, understanding what promotional offers (e.g., sales, deals, coupons, and/or the like) are available and matching available offers with the current demand of a household is a never-ending task. For this reason, many consumers do not take advantage of nearly as many offers as are available. Further, producers, distributors, and/or sellers of household purchases can miss out on additional sales if consumers are not aware of their current needs and/or available promotional offers. Thus, at least some of the subject matter described herein relates to systems and methods for monitoring household inventory and/or automatically generating promotional data based on household inventory.

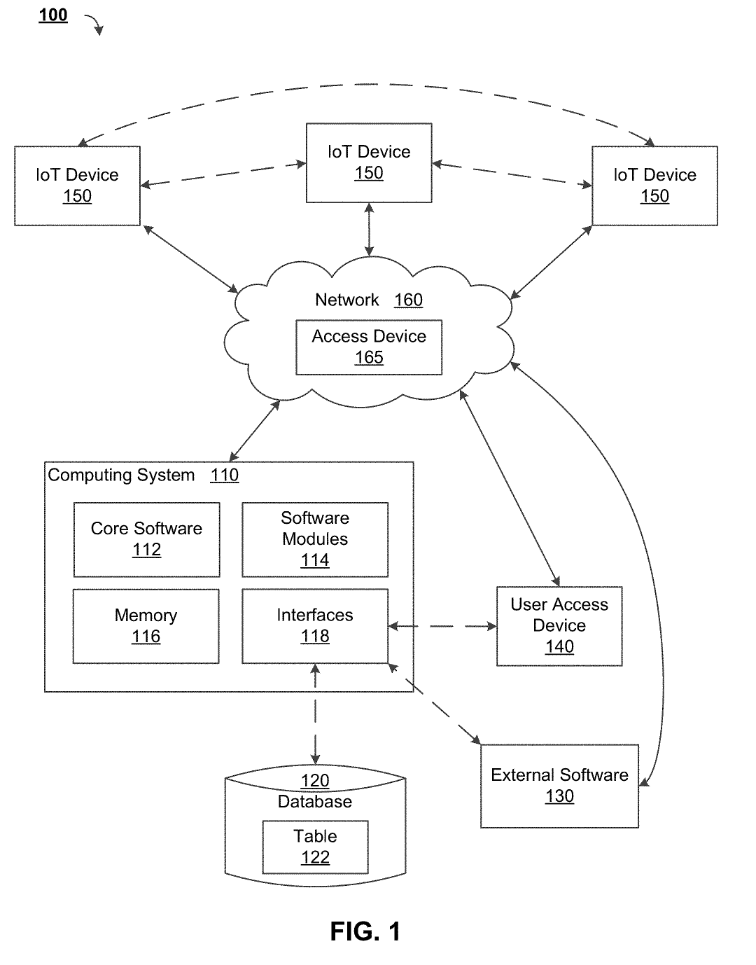

FIG. 1 illustrates a functional block diagram of a system 100 in which features consistent with the described subject matter may be implemented. As illustrated, the system 100 can include a computing system 110 capable of communicating with a user access device 140 and/or one or more Internet of things (IoT) devices 150. In some aspects, the computing system can utilize one or more interfaces 118 for communication. Communication among the devices can be through the use of direct communications, such as through the use of a wireless connection like Bluetooth, near-field communication (NFC), ZigBee, and/or the like, and/or a hard wire connection such as universal serial bus (USB). Communication can additionally or alternatively occur through indirect communications, such as over a network 160 (e.g., a local area network, a wide area network, a wireless network, the Internet, or the like).

Communication over the network 160 can utilize a network access device 165, such as a base station, a Node B, an evolved Node B (eNB), an access nodes (ANs), a hotspot, and/or the like. In some aspects, the user access device 140 and/or any of the IoT devices 150 can include personal computers, desktop computers, laptops, workstations, cell phones, digital media devices, smart phones, smart watches, PDAs (personal digital assistants), tablets, hardware/software servers, sensors, sensor devices, terminals, access terminals (ATs), mobile stations, user equipment (UE), subscriber units, and/or the like. Wired or wireless communication among the computing system 110, user access device 140, and/or IoT devices 150 can occur according to various protocols and/or access technologies (e.g., Global System for Mobile Communication (GSM), Universal Mobile Telecommunications System (UMTS), technologies developed by IEEE such as WiFi and/or Bluetooth, technologies developed by the Third Generation Partnership Project (3GPP) or 3GPP2 such as Long Term Evolution (LTE) and/or CDMA2000, etc.).

In some aspects, one or more of the IoT devices 150 can be configured to operate and/or communicate according to low-power techniques. For example, the IoT devices 150 can be configured to utilize less battery power, less processing power, and/or utilize sleep states. In some implementations, at least a portion of the IoT devices 150 can be autonomous or semi-autonomous. For example, the IoT devices 150 can store configuration information for themselves and/or for other IoT devices 150. Thus, a user may be able to access one IoT device 150 and change the configuration of other IoT devices 150, such as any other IoT device 150 that is, for example, in a chain with the accessed IoT device 150. Software modifications/updates may be provided to multiple IoT devices 150 in a similar manner. In some implementations, a “chain” can be established via blockchain techniques, although information may be provided in other ways/according to other techniques. In some implementations, blockchain techniques can include the use of a distributed database that maintains a continuous/growing list of records (e.g. “blocks”), which can be secured from tampering/revision, and/or contain timestamps and/or links to a previous block.

In some aspects, an IoT device 150 can store configurations for the complete active and/or passive set of connected IoT devices 150, which may be encrypted. For example, in a “smart home” setup, a device for climate can measure humidity, temperature, etc., and a device for controlling the heating/air-conditioning can have an active connection to the device for climate and act upon certain measurements. A passive connection may additionally or alternatively exist, where a sensor detects motion and provides an indication to a light switch to turn on a light. In some implementations, each of these devices in the smart home setup can belong to a single system and/or contain configuration information for the complete chain. However, some of the configuration data can be active (e.g., used by the interaction) and/or some of the configuration data can be passive (e.g., to keep the collective chain alive).

As illustrated, the computing system 110 can include core software 112 and/or one or more software modules 114. The core software 112 can provide one or more features of a high-level programming software system. The software modules 114 can provide more specialized functionality. For example, the core software 112 and/or software modules 114 can include IoT management and/or database management features. In some aspects, the core software 112 or other similar software/hardware can be capable of accessing a database layer, such as the database 120, which includes at least one table 122, which can in turn include at least one column. The database table 122 can store any kind of data, potentially including but not limited to definitions of business scenarios, business processes, and one or more business configurations as well as transactional data, metadata, master data, etc. relating to instances or definitions of the business scenarios, business processes, and one or more business configurations, and/or concrete instances of data objects and/or business objects that are relevant to a specific instance of a business scenario, business process, and/or the like.

In some aspects, the core software 112 can be configured to load the information from the database 120 to memory 116 (e.g., main memory) in response to receipt of a query instantiated by a user or computer system through one or more IoT devices 150, the user access device 140, the external software 130, and/or the like. In some implementations, all (or substantially all) of the operational data of the database 120 can reside in-memory (e.g., in random-access memory (RAM)). Although the database 120 is illustrated as being separate and, at times, described as being separate from the computing system 110, in various implementations, at least a portion of the database 120 can be located within the computing system. The database 120 may be a column store database and/or the computing system 110 may be configured to perform OLTP (online transaction processing) and/or OLAP (online analytical processing), which can include complex analytics and tasks.

In some aspects, one or more of the software modules 114 can be configured to utilize data stored in the memory 116, data stored in the database 120, and/or data otherwise accessible to the computing system 110. As further illustrated, the computing system 110 can be capable of utilizing external software 130. In some aspects, the external software 130 can provide additional functionalities or services which may not be available at the computing system 110. In some aspects, the external software 130 may include cloud services. In some aspects, the computing system 110 can aggregate or otherwise provide a gateway via which users can access functionality provided the external software 130. In some implementations, the database 120 and/or the external software 130 can be located across one or more servers, and/or communication among the computing system 110, the database, and/or the external software 130 can occur over the network 160.

At least a portion of the illustrated system 100 may include hardware and/or software that interacts with a database, users, and/or other software applications for defining, creating, and/or updating data, for receiving, handling, optimizing, and/or executing database queries, and/or for running software/applications (e.g., software modules 114, and/or external software 130) which utilize a database. In some aspects, the database 120 can be a structured, organized collection of data, such as schemas, tables, queries, reports, views, and/or the like, which may be processed for information. The database 120 may be physically stored in a hardware server or across a plurality of hardware servers. In some aspects, the system 100 may be implemented as a cloud-based system and/or an IoT system.

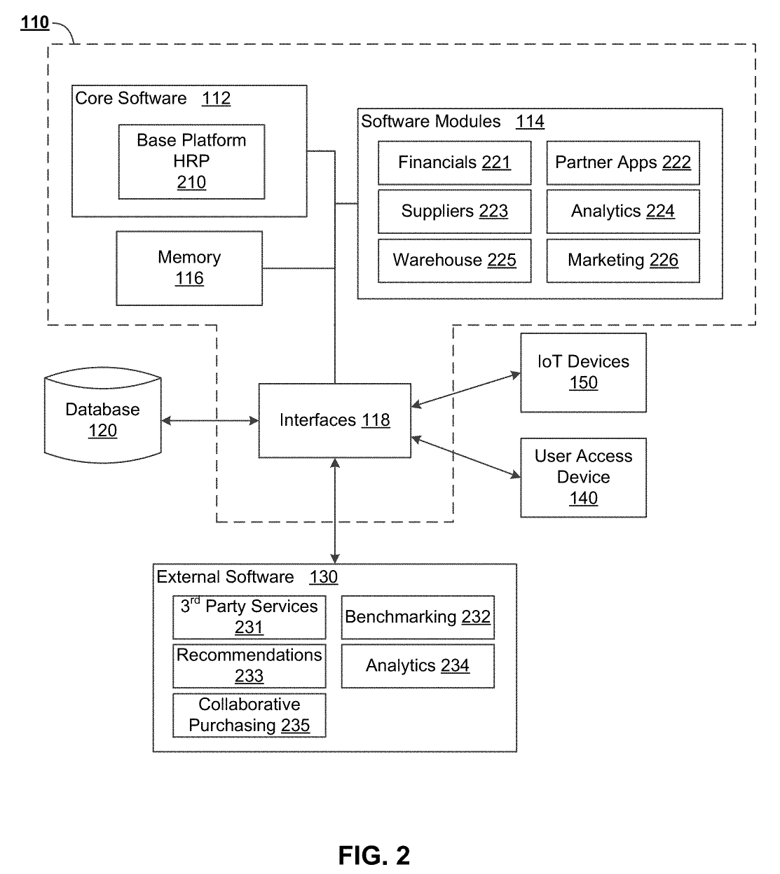

FIG. 2 illustrates another functional block diagram of components of the system 100 of FIG. 1, in accordance with some example implementations. As illustrated, the core software 112 can include base platform home resource planning (HRP) software 210.

As further illustrated, the software modules 114 can include a financials module 221, a partner application module 222, a supplier module 223, an analytics module 224, a warehouse module 225, and/or a marketing module 226. The financials module 221 can be configured to track and/or analyze household spending information. For example, the financials module 221 can be configured to identify purchasing patterns based on purchasing history and/or may be configured to provide recommendations or other information about the patterns to the household.

The partner application module 222 can be configured to generate and/or provide information on one or more partners, companies, and/or affiliated entities. In some aspects, this information can include information on what products/services each entity sells/provides, pricing information, availability information, store/product locations, and/or other information about entities and their products/services. In some aspects, the partner module 222 can provide warranty information for certain products and/or contact information for a manufacturer to contact if issues arise. Product information can include nutrition facts, and in some aspects calculations about the healthiness of a product can be made. The supplier module 223 can include information on suppliers, companies, and/or affiliated entities. For example, this information can include information on what products each supplier provides, pricing information, availability information, distribution information, and/or other information about the suppliers and their products. In some aspects, the partner module 222 and/or the supplier module 223 can be utilize to issue warnings to households in the event re-calls are issued, warning from the World Health Organization (WHO) or another entity exist, and/or the like.

The analytics module 224 can be configured to generate and/or provide information on a household's purchasing habits. For example, based on when certain household purchases are present in a household, how long the household purchases are present, and/or how often the household purchases are present, the analytics module 224 can determine how often a household need or wants a particular household purchase.

The warehouse module 225 can be configured to maintain, organize, and/or provide information on the inventory of a household (e.g., how much of a particular product is present). In some aspects, the warehouse module 225 can be configured to also keep track of the location of household products. In various implementations, the warehouse module 225 can be configured to receive inventory information from one or more external sources and/or sensors.

For example, in some aspects, a “paperless” cash register can be configured to generate an electronic receipt that can read by computer devices. In some aspects, the computer devices can access the electronic receipt through the use of a unique code (e.g., a QR code, barcode, and/or the like) identifying the receipt. In some aspects, this code can be physically printed on a paper receipt or displayed in an electronic format (e.g., via an electronic display at/near the cash register, a web browser, etc.). In accordance with these aspects, a user can scan the code through their smartphone or other device capable of reading/capturing the code, which may in-turn allow the user to access the electronic receipt and/or information about the transaction. In some implementations, access to the electronic receipt may additionally or alternatively be provided to the user through other means, such as through the use of NFC, Bluetooth, short-message services (SMS), email, and/or the like. In some aspects, the electronic receipt can be displayed to a user and/or read by a computer device.

In order to provide the electronic receipt to the correct customer, the cash register may be configured to identify the customer by their personal loyalty identification number, identification card, phone number, email address, name, and/or the like. In some implementations, the user can be identified based on the proximity of their phone, other electronic device, and/or a radio frequency identification (RFID) object to the cash register. In some aspect, the cash register can be configured to provide access to and/or a copy of the electronic receipt to an identified user based on preferred method(s) of delivery specified by the customer. For example, in some implementations, a user can be identified, and once they pass the cash register after completing a transaction, the receipt can be provided to the user's electronic device.

In some aspects, the electronic receipt can contain information about the purchase, such as what products were purchased, quantities of each product, prices of each product, nutrition information for at least some of the products, a time/date of the purchase, a location and/or store whether the purchase was made, expiration dates of relevant products, warranty information for relevant products, discounts applied, coupons/codes used, an identification number for the transaction or receipt, and/or the like. In various implementations, the electronic receipts and/or related information can be stored at a retail loyalty system. The retail loyalty system can provide a mobile application, which the user may access through their smartphone to view the receipt and related information, such as historical information. In some implementations, the electronic receipts and/or related information can additionally or alternatively be stored at the computing device 110, where it can be associated with a household and/or a particular member of the household (e.g., based on the identification of the purchaser).

In some aspects, this data (or at least a portion thereof) can be provided to programs, such as one or more of the software modules 114 in order to calculate inventory, consumption, expenditures, warranties (where applicable), and/or the like. In some aspects, the base HRP software 210 can be configured to receive and/or process the electronic receipt, and provide relevant information to the relevant software modules 114.

The software modules 114 can, in turn, analyze the receipt and/or associated information. For example, the analytics module 224 may use the receipt to evaluate the effectiveness of an advertisement, even though the customer has purchased “offline.” This ability can enable a marketing module 226 and/or companies to provide more relevant advertisement information. For example, analyzing the purchasing history of a household can allow a company (through the system) to offer warranty enhancements when they are relevant, provide an advertisement when is almost out empty, and/or the like. This can reduce wasted advertising expenses by decreasing the likelihood that advertisement is not relevant, and can provide the customer with relevant offers and potentially save the customer money. For example, if a customer just bought a coffee machine, the marketing module 226 may determine that advertisements for new coffee machines should not be provided to the user, and/or that advertisements for coffee, filters, capsules, and/or the like should be made.

As a non-limiting example of a benefit of the use of the paperless cashier system and/or electronic receipts, paper waste can be reduced, the customer's check-out time can be reduced, and/or the process of keeping track of purchases can be simplified.

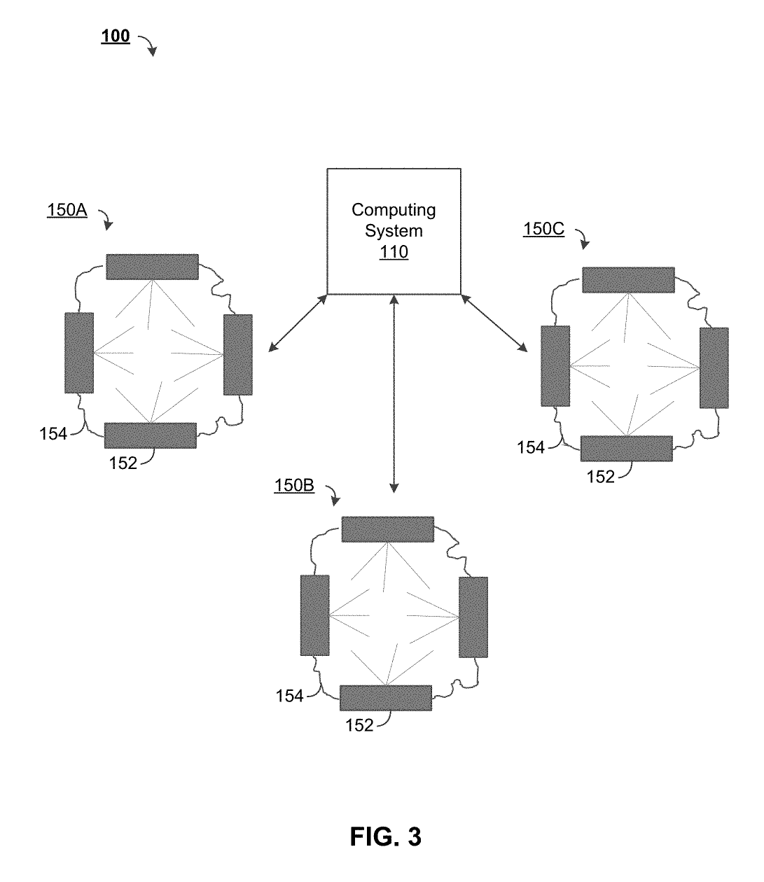

In some aspects, information may be received/processed by the computing system 110 through the use of one or more of the IoT devices 150. For example, FIG. 3 illustrates a functional block diagram of the computing system 110 of FIG. 1 in communication with a plurality of IoT devices 150A-C, in accordance with some example implementations. In some implementations, the IoT devices 150A-C can include one or more sensors and/or cameras, which can be configured to detect motion, scan barcodes (e.g., via lasers), receive and/or process RFID information, identify objects, and/or the like. For example, the IoT devices 150A-C can be configured to generate a multi-dimensional (e.g., two or three) space which can be used to determine when an object crosses through the space. Based upon detecting that an object crosses from one side of the space to another, the IoT devices 150A-C can make a determination of what the object is and/or perform additional actions based upon the determination.

As illustrated, the IoT devices 150A-C can include one or more modules 152 connected to each other through wires 154, such as zip wires. In some aspects, the modules 152 may not be connected through a wired connection, and can be configured to instead use a wireless connection. One of the modules 152 can be designated as the “main module”, which may contain additional components and/or functionalities. For example, the main module 152 can be configured to receive information from other modules 152 and/or communicate information obtained by the IoT device 150 back to the computing system 110. The main module 152 may contain storage, which may be used to store operational data and/or information obtained during operation. In some aspects, each of the modules 152 may be manufactured to include the same components and/or the designation/selection of the main module can be performed by a user or arbitrated by the modules 152. However, in some implementations, none of the modules 150 may be designated as a main module, and each may transmit information to the computing system 110.

In some implementations, the IoT devices 150A-C can act without the computing system 110. For example, the IoT devices 150A-C can include a system/software for operating itself and storage for data received in collaboration with the other IoT devices 150A-C (e.g., via blockchain technology). The IoT devices 150A-C can be grouped to act as a network and exchange transaction data, configuration data, software code, and/or the like. In accordance with some implementations, each IoT device 150A-C can store “community” code. This code can enable grouped IoT devices 150A-C to update and/or configure a new device automatically when one device is not functioning properly, since the devices all have the necessary data and knowledge of which device is being replaced. If a new IoT device 150 is added to a group, it may be possible to automatically configure the new IoT device 150, if provides its intention to the group.

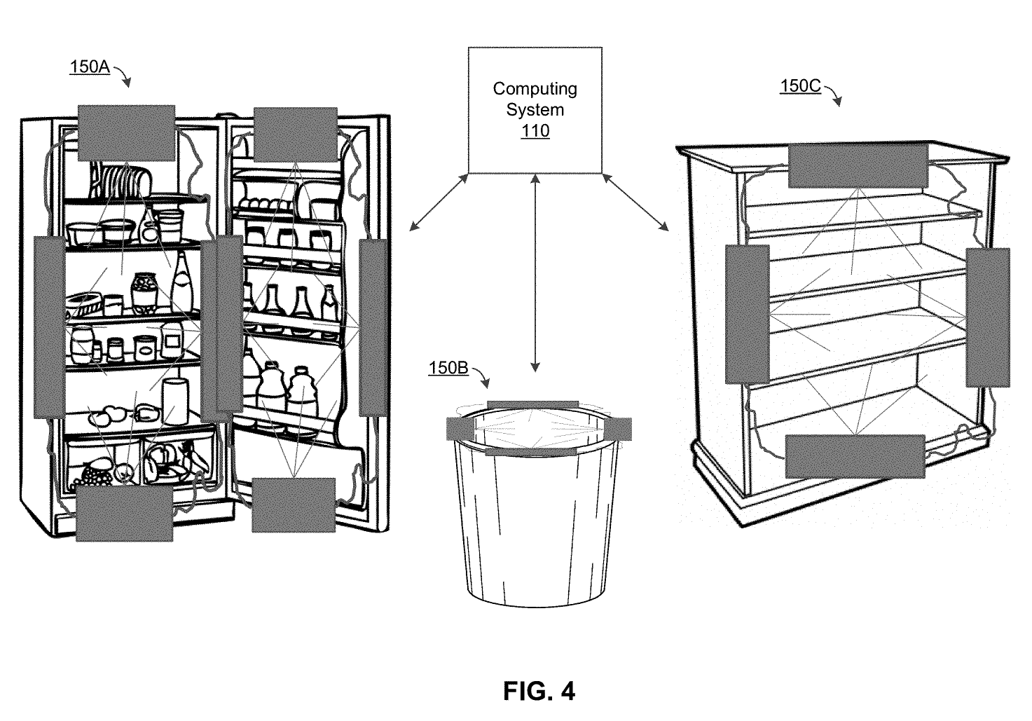

FIG. 4 illustrates an example implementation of the computing system 110 and the plurality of IoT devices 150A-C of FIG. 3. As illustrated, a first IoT device 150A can be affixed to an interior of a refrigerator and/or freezer, a second IoT device 150B can be affixed to a trash and/or recycling receptacle, and/or a third IoT device 150C can be affixed to a food storage area, such as a pantry, cupboard, and/or the like. In some aspects, the IoT device 150A-C and/or the modules can be configured to reflect the respective role(s) of the (e.g., designate the IoT device 150A as the fridge scanner via the use of one or more attributes).

In an example implementation, a user may place groceries into the refrigerator or dry storage, and these items can be identified by the first IoT device 150A or the third IoT device 150C. Additionally, based on the direction of the groceries, the IoT devices 150A and 150C, for example, may determine whether the groceries are being placed into storage or being removed from storage. When a member of the household removes an item from the refrigerator or dry storage, the first IoT device 150A or the third IoT device 150C may identify the groceries and/or direction of movement to determine that the groceries are now in use. Similarly, the second IoT device 150B may detect when an item is placed in the trash/recycling receptacle, and may make a determination that the item is spent (e.g., no longer in stock/use).

Information about the determined location of the groceries can be communicated back to the computing system 110, which may be further processed to make additional determinations. For example, the IoT scanners 150A-C can identify specific products and/or when the products are moved into or out of the designated areas, and/or the computing system 110 can keep track of the location, amount, etc. of household products currently located within the household. In some implementations, the computing system 110 can be configured to determine how many times a household places a product “in use” before throwing the product away to predict when the household will run out of the product. Determining whether a household is about to run out of a product can be based on one or more threshold values. In some aspects, information obtained via the IoT devices 150A-C can be provided to other scanners, other apps, other devices, and/or the like.

In some implementations, the IoT devices might remain in a low power mode until the detection of an event, such as the detection of motion, detection of proximity to the computing system 110 or user access device 140, determination that a certain amount of time has elapsed, and/or upon instruction to provide information to the computing system 110 or user access device 140. Although specific locations and/or uses of the sensors/IoT devices are described, other locations and/or uses are possible.

The IoT devices 150A-C can be configured to interpret the data they receive during operation in collaboration with other scanners or devices. For example, in some implementations, the IoT devices 150A-C can be configured to receive information on a recent purchase made by a member of the household (e.g., through the electronic receipt described herein), and may be configured to match items placed into a dedicated storage area with the recently purchased items. If all of the items match, then the data can be considered valid. If some of the items are missing, then the IoT device 150A-C can be configured to determine what items are missing and/or notify the computing system 110 and/or a user. In turn, the user may provide information regarding why the items are missing (e.g., the household gave a gallon of milk to a neighbor) and/or may be provided with an opportunity to allow the IoT devices 150 to recognize that the item is actually present in one of the dedicate storage areas. In some implementations, the computing system 110 may instead receive the purchase information, and compare the information against data received from the IoT sensors 150A-C. Similar methods for detecting that items are missing, notifying a user, and/or resolving the discrepancies may be utilized by the computing system 110.

Referring back to FIG. 2, the marketing module 226 can be configured to generate and/or provide marketing information to a user of a household. In some aspects, the marketing module 226 can utilize information from the warehouse module 225 to determine whether a household is out of (or almost out of) a certain household purchase, and/or can use the analytics module 224 to determine whether or not the household it likely to purchase more in the near future. If the marketing module 226 determines that a household is likely to purchase a particular item, the marketing module 226 can access the partner applications module 222 and/or the supplier module 223 to provide an advertisement, coupon, or other marketing information to the household.

In some aspects, the marketing module 226 can keep track of offers/advertisement relevant to a particular household. For example, the marketing module 226 may be able to map available offers to the current needs of the household based on information determined through the use of the analytics module 224, the warehouse module 225, and/or the like. In some aspects, a user may designate one or more suppliers which the household uses, a preference among the suppliers, and/or the like, which can be used to further search through available offers and/or identify offers relevant to a household. If the household runs out of (or is about to run out of) certain products, the marketing module 226 can compare the shortage with current advertisements/promotions available and/or generate a shopping list for the user. In some aspects, the shopping list can be generated to include the best way to get to the stores with the best offers. In some aspects, the shopping list can include information on what aisles each product is located within the store and a recommended “plan of attack” for the user within the store in a manner that reduces the time spent searching for specific items.

In some aspects, one or more of the software modules 114 can be configured to utilize information received from external software 130. For example, as illustrated, the external software 130 can include third party services software 231, benchmarking software 232, recommendations software 233, analytics software 234, and/or collaborative purchasing software 235. The third party services software 231 can be used to obtain information on advertisements (e.g., online and/or printed), loyalty program benefits coupons, and/or the like. The benchmarking software 232 can be used to compare the spending and/or usage of a household with peer groups, which can be performed anonymously. For example, in a geographical area encompassing multiple households, the spending habits of the households can be compared among each other. In some aspects, only households which are similar might be compared (e.g., households with similar salaries, family size, age of family members, and/or the like). Based on the comparisons, the benchmarking module 232, for example, can determine that a particular household is spend 10% more on chips, buying more cigarettes than households with members of the same/similar age, not as healthy as other households in the country, and/or the like.

The recommendations software 233 can be used to determine what products other households with similar purchasing/use histories buy/use.

The analytics software 234 can be used to make determination on how a household is performing relative to other households. Other households which are used for comparison can be selected based on demographic, geographic location, household size, age of household members, and/or the like.

The collaborative purchasing software 235 can be used to determine whether multiple households need/want a specific purchase around the same time and/or whether the multiple households could benefit from placing a group order for the purchase at the same time. For example, if multiple households in an area need/want a television, then the collaborative purchasing software 235 can group these households (e.g., in a manner that is anonymous to each household) and/or create a group order through a company to obtain a volume discount. Thus, the manufacturer/distributor/retailer of the televisions can make multiple sales and the customers can obtain a higher discount than purchasing on their own. In some aspects, information received from the external software can be stored in the database 120.

In various implementations, information may additionally or alternatively be manually entered into the database 120, which may in turn be utilized by one or more of the software modules 114. For example, the computing system 110, the user access device 140, and/or one or more of the IoT devices 150 may be configured to allow a user to scan in coupons, leaflets, and/or the like. In some aspects, the user may provide specific preferences for purchasing, such as dietary restrictions, whether or not the household (or at least a portion) is vegan or vegetarian, preferred companies and/or products to avoid, favorite companies, and/or the like. This information may be further considered along with other data when analyzing a household's purchasing patterns, providing purchasing suggestions, and/or the like.

As a non-limiting example of a benefit, the identification of opportunities for providing targeted marketing information to a household based on the demands and/or purchasing history of the household can create opportunities for consumers, suppliers, manufacturers, and/or the like which are more likely to be seen and acted upon by the consumers. Companies invest a large amount of money into advertising, and the opportunity to communicate with a consumer at the moment in time when a purchase is the most relevant to the consumer is invaluable. Through the use of the system 100, more direct integration of the physical household and products used by the household into computer-based systems can be provided, which can result in improved efficiency, accuracy, and/or economic benefit.

Although specific modules are illustrated and described as being part of the software modules 114 and specific software is illustrated and described as being part of the external software 130, one or more of the modules and/or software may be present in a different location. For example, in various implementations, one or more of the software modules 114 can be external to the computing system 110 (e.g., as cloud-based services) and/or some of the external software 130 can be internal to the computing system 110.

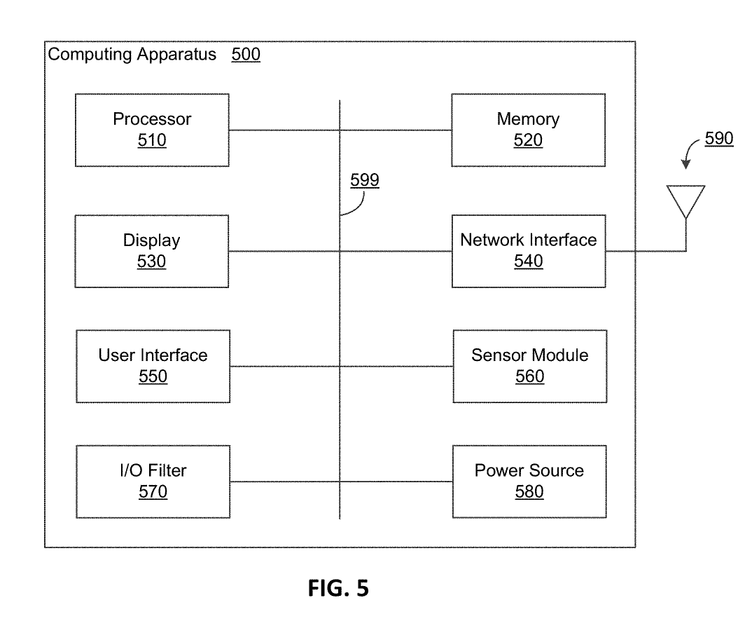

FIG. 5 illustrates an example computing apparatus 500 which may be used to implement one or more of the described devices and/or components, in accordance with some example implementations. For example, at least a portion of the computing apparatus 500 may be used to implement at least a portion of the computing device 110, an apparatus providing the database 120, an apparatus providing the external software 130, the user access device 140, one or more of the IoT devices 150, and/or the access device 165. Computing apparatus 500 may perform one or more of the processes described herein.

As illustrated, computing apparatus 500 may include one or more processors such as processor 510 to execute instructions that may implement operations consistent with those described herein. Apparatus 500 may include memory 520 to store executable instructions and/or information. Memory 520 may include solid-state memory, solid-state disk drives, magnetic disk drives, or any other information storage device. In some aspects, the memory 520 may provide storage for at least a portion of a database (e.g., the database 120 or some other organization of data). Apparatus 500 may include a network interface 540 to a wired network or a wireless network, such as the network 160 of FIG. 1. Wireless networks may include WiFi, WiMax, and cellular networks (2G/3G/4G/5G), and/or any other wireless network. In order to effectuate wireless communications, the network interface 540, for example, may utilize one or more antennas, such as antenna 580.

Apparatus 500 may include one or more user interface, such as user interface 550. The user interface 550 can include hardware or software interfaces, such as a keyboard, mouse, or other interface, some of which may include a touchscreen integrated with a display 530. The display 530 may be used to display information such as promotional offers or current inventory, provide prompts to a user, receive user input, and/or the like. In various implementations, the user interface 450 can include one or more peripheral devices and/or the user interface 550 may be configured to communicate with these peripheral devices.

In some aspects, the user interface 550 may include one or more of the sensors described herein and/or may include an interface to one or more of the sensors described herein. The operation of these sensors may be controlled at least in part by a sensor module 560. The apparatus 500 may also comprise and input and output filter 570, which can filter information received from the sensors or other user interfaces, received and/or transmitted by the network interface, and/or the like. For example, signals detected through the sensors can be passed through the filter 570 for proper signal conditioning, and the filtered data may then be passed to the microcontroller sensor module 560 and/or processor 510 for validation and processing (e.g., before transmitting results or an indication via the network interface 540). The apparatus 500 may be powered through the use of one or more power sources, such as power source 590. As illustrated, one or more of the components of the apparatus 500 may communicate and/or receive power through a system bus 599.

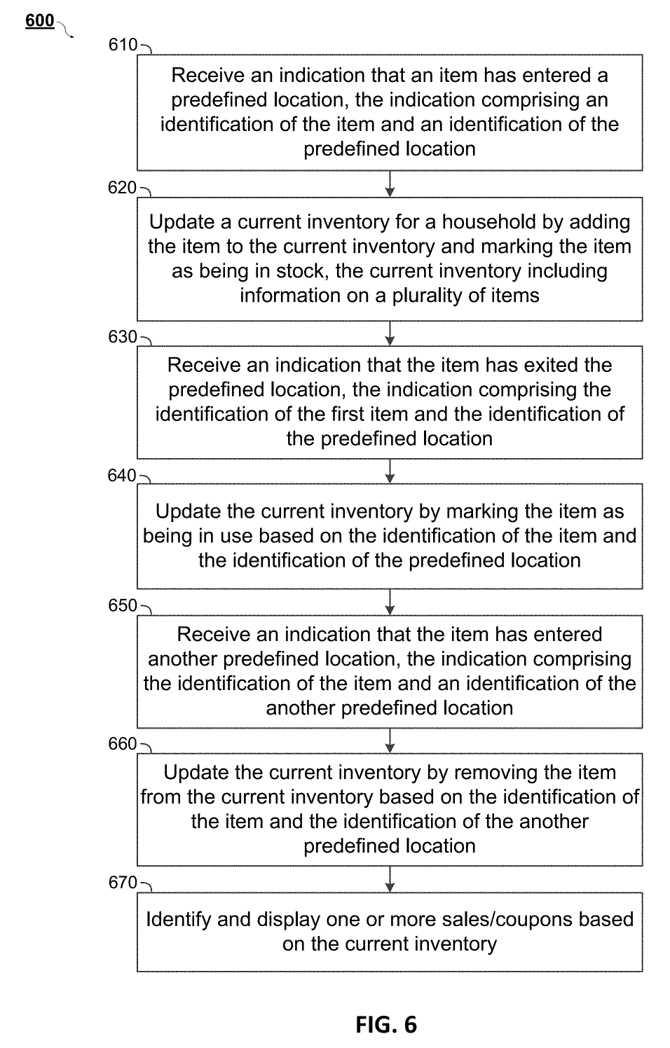

FIG. 6 illustrates a flowchart of a method for monitoring inventory and/or automatically generating promotional data, in accordance with some example implementations. In various implementations, the method 600 (or at least a portion thereof) may be performed by one or more of the computing system 110, an apparatus providing the database 120, an apparatus providing the external software 130, the user access device 140, one or more of the IoT devices 150, the access device 165, the apparatus 500, other related apparatuses, and/or some portion thereof. In some aspects, the apparatus 500 may be regarded as a server.

Method 600 can start at operational block 610 where the apparatus 500, for example, receives an indication that an item has entered a predefined location, the indication comprising an identification of the item and an identification of the predefined location. In various implementations, the indication can be received from a computing device, such as a device with a plurality of sensors for identifying items (e.g., a device similar to one or more of the IoT devices 150). In some aspects, the apparatus 500 can be configured to communicate over a wireless network with one or more of such devices and/or the devices can be configured to utilize a sleep state (e.g., power save mode) outside of active communications (e.g., with the apparatus). In some implementations, the predefined location can include a refrigerator, a freezer, a cabinet, a shelf, and/or the like.

Method 600 can proceed to operational block 620 where the apparatus 500, for example, updates a current inventory for a household by adding the item to the current inventory and marking the item as being in stock, the current inventory including information on a plurality of items.

Method 600 can proceed to operational block 630 where the apparatus 500, for example, receives an indication that the item has exited the predefined location, the indication comprising the identification of the first item and the identification of the predefined location.

Method 600 can proceed to operational block 640 where the apparatus 500, for example, updates the current inventory by marking the item as being in use based on the identification of the item and the identification of the predefined location.

Method 600 can proceed to operational block 650 where the apparatus 500, for example, receives an indication that the item has entered another predefined location, the indication comprising the identification of the item and an identification of the another predefined location. In some implementations, the another predefined location can include a trash receptacle or a recycling receptacle.

Method 600 can proceed to operational block 660 where the apparatus 500, for example, updates the current inventory by removing the item from the current inventory based on the identification of the item and the identification of the another predefined location.

Method 600 can proceed to operational block 670 where the apparatus 500, for example, identifies and displays one or more sales and/or one or more coupons based on the current inventory. In various implementations, identification and displaying can be separate operations, and/or one can be performed without the other or by separate devices. In some aspects, electronic advertisement information may be received by the apparatus 500, and/or the identification of the one or more sales or coupons can be from the electronic advertisement information. In some implementations, method 600 can additionally or alternatively involve the apparatus 500, for example, generating a shopping list for the household based on the current inventory and the one or more sales or coupons. In some aspects, the shopping list can be transmitted via at least one wireless connection to a user access device registered for the household.

Method 600 can additionally or alternatively involve the apparatus 500, for example, generating historical data for at least a portion of the plurality of items. For example, the historical data including an average time that the at least the portion of the plurality of items are in stock within the household. The apparatus 500 can determine an expected time at which the first item will not be in stock (e.g., spent) based on the historical data. The apparatus 500 can further provide an indication of the expected time to a user. For example, the apparatus 500 can provide a notification to the user through the use of a user interface (e.g., a display), which can be part of the apparatus 500 or part of another device.

Method 600 can additionally or alternatively involve the apparatus 500, for example, receiving an electronic receipt for a purchase made by a member of the household and/or updating the current inventory based on the electronic receipt, where the electronic receipt comprises indications of purchased items and quantities of the purchased items. Other information can be accessed through the electronic receipt, which may be stored along with the item(s) in the current inventory. In some implementations the method 600 can involve the apparatus 500, for example, determining estimated expiration dates of items purchased and/or placed within storage (e.g., the fridge, freezer, dry storage, etc.). The expiration date information can be tracked for presentation to the user and/or additional analysis.

For example, if milk is place into the refrigerator, the barcode may be scanned to determine the expiration date, the label of the milk may be scanned to read the expiration date (or some indication thereof) printed on the carton, expiration date information may be provided through the electronic receipt, an expiration date estimation formula may be utilized, and/or the like. To estimate the expiration date of a product, the date of purchase/entry of the product into the household can be compared against historical data associated with the product, which may include data tracked by the apparatus 500 and/or another apparatus within the system 100, or may be provided by a producer, consumer watchdogs, governmental agencies, and/or the like. In some aspects, the method 600 can involve the apparatus 500, for example, using the warehouse and/or electronic receipt information to determine a current value of the consumer products in the household, which can be broken down by type (e.g., total value of groceries).

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic input, speech input, tactile input, and/or the like. Other possible input devices include touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above.

The illustrated methods are exemplary only. Although the methods are illustrated as having a specific operational flow, two or more operations may be combined into a single operation, a single operation may be performed in two or more separate operations, one or more of the illustrated operations may not be present in various implementations, and/or additional operations which are not illustrated may be part of the methods. In addition, the logic flows depicted in the accompanying figures and/or described herein do not necessarily require the particular order shown, or sequential order, to achieve desirable results. Other implementations may be within the scope of the following claims.

What is claimed is:

1. An apparatus comprising:
at least one processor; and
at least one memory storing instructions which, when executed by the at least one processor, cause operations comprising:
receiving, from at least one Internet of things (IoT) device, a first indication that a first item has entered a predefined location, the first indication comprising an identification of the first item and an identification of the predefined location;
updating a current inventory for a household by adding the first item to the current inventory and marking the first item as being in stock, wherein the current inventory includes information on a plurality of items;
receiving, from the at least one IoT device, a second indication that the first item has exited the predefined location, the second indication comprising the identification of the first item and the identification of the predefined location; and
updating the current inventory by marking the first item as being in use based on the identification of the first item and the identification of the predefined location.

2. The apparatus of claim 1, wherein the operations further comprise:
receiving, from at least another IoT device, a third indication that the first item has entered a second predefined location, the third indication comprising the identification of the first item and an identification of the second predefined location; and
updating the current inventory by removing the first item from the current inventory based on the identification of the first item and the identification of the second predefined location.

3. The apparatus of claim 2, wherein:
the predefined location comprises at least one of a refrigerator, a freezer, a cabinet, and a shelf; and
the second predefined location comprises at least one of a trash receptacle or a recycling receptacle.

4. The apparatus of claim 2, wherein the apparatus comprises a user access device or a computing system configured to communicate over a wireless network with the at least one IoT device and the at least another IoT device, wherein the at least one IoT device and the at least another IoT device each comprise a device with a plurality of sensors for identifying items, and wherein the at least one IoT device and the at least another IoT device are each configured to utilize a sleep state outside of active communications.

5. The apparatus of claim 1, wherein the operations further comprise:
generating historical data for at least a portion of the plurality of items, the historical data including an average time that the at least the portion of the plurality of items are in stock within the household;
determining, based on the historical data, an expected time at which the first item will not be in stock; and
providing an indication of the expected time to a user.

6. The apparatus of claim 1, wherein the operations further comprise:
receiving electronic advertisement information; and
identifying, based on the current inventory, one or more sales and/or one or more coupons from the electronic advertisement information.

7. The apparatus of claim 6, wherein the operations further comprise:
generating, based on the current inventory and the one or more sales or coupons, a shopping list for the household; and
transmitting, via at least one wireless connection, the shopping list to a user access device registered for the household.

8. The apparatus of claim 1, wherein the operations further comprise:
receiving an electronic receipt for a purchase made by a member of the household; and
updating the current inventory based on the electronic receipt, wherein the electronic receipt comprises indications of purchased items and quantities of the purchased items.

9. The apparatus of claim 1, further comprising another IoT device including a plurality of sensors for identifying items, wherein the at least one IoT device includes a plurality of sensors for identifying items, and wherein the at least one IoT device and the another IoT device are in a blockchain configuration with each other.

10. A method comprising:
receiving, by a computing apparatus and from at least one Internet of things (IoT) device, a first indication that a first item has entered a predefined location, the first indication comprising an identification of the first item and an identification of the predefined location;
updating, by the computing apparatus, a current inventory for a household by adding the first item to the current inventory and marking the first item as being in stock, wherein the current inventory includes information on a plurality of items;
receiving, by the computing apparatus and from the at least one IoT device, a second indication that the first item has exited the predefined location, the second indication comprising the identification of the first item and the identification of the predefined location; and
updating, by the computing apparatus, the current inventory by marking the first item as being in use based on the identification of the first item and the identification of the predefined location.

11. The method of claim 10, further comprising:
receiving, by the computing apparatus and from at least another IoT device, a third indication that the first item has entered a second predefined location, the third indication comprising the identification of the first item and an identification of the second predefined location; and
updating, by the computing apparatus, the current inventory by removing the first item from the current inventory based on the identification of the first item and the identification of the second predefined location, wherein the predefined location comprises at least one of a refrigerator, a freezer, a cabinet, and a shelf, and wherein the second predefined location comprises at least one of a trash receptacle or a recycling receptacle.

12. The method of claim 11, wherein the computing apparatus comprises a user access device or a computing system configured to communicate over a wireless network with the at least one IoT device and the at least another IoT device, wherein the at least one IoT device and the at least another IoT device each comprise a device with a plurality of sensors for identifying items, and wherein the at least one IoT device and the at least another IoT device are each configured to utilize a sleep state outside of active communications.

13. The method of claim 10, further comprising:
generating, by the computing apparatus, historical data for at least a portion of the plurality of items, the historical data including an average time that the at least the portion of the plurality of items are in stock within the household;
determining, by the computing apparatus and based on the historical data, an expected time at which the first item will not be in stock; and
providing an indication of the expected time to a user.

14. The method of claim 10, further comprising:
receiving, by the computing apparatus, electronic advertisement information;
identifying, by the computing apparatus and based on the current inventory, one or more sales and/or one or more coupons from the electronic advertisement information;
generating, by the computing apparatus and based on the current inventory and the one or more sales or coupons, a shopping list for the household; and
transmitting, by the computing apparatus and via at least one wireless connection, the shopping list to a user access device registered for the household.

15. A non-transitory computer program product storing instructions which, when executed by at least one hardware data processors, cause operations comprising:
receiving, by a computing apparatus and from at least one Internet of things (IoT) device, a first indication that a first item has entered a predefined location, the first indication comprising an identification of the first item and an identification of the predefined location;
updating, by the computing apparatus, a current inventory for a household by adding the first item to the current inventory and marking the first item as being in stock, wherein the current inventory includes information on a plurality of items;
receiving, by the computing apparatus and from the at least one IoT device, a second indication that the first item has exited the predefined location, the second indication comprising the identification of the first item and the identification of the predefined location; and
updating, by the computing apparatus, the current inventory by marking the first item as being in use based on the identification of the first item and the identification of the predefined location.

16. The non-transitory computer program product of claim 15, wherein the operations further comprise:
receiving, by the computing apparatus and from at least another IoT device, a third indication that the first item has entered a second predefined location, the third indication comprising the identification of the first item and an identification of the second predefined location; and
updating, by the computing apparatus, the current inventory by removing the first item from the current inventory based on the identification of the first item and the identification of the second predefined location, wherein the predefined location comprises at least one of a refrigerator, a freezer, a cabinet, and a shelf, and wherein the second predefined location comprises at least one of a trash receptacle or a recycling receptacle.

17. The non-transitory computer program product of claim 16, wherein the computing apparatus comprises a user access device or a computing system configured to communicate over a wireless network with the at least one IoT device and the at least another IoT device, wherein the at least one IoT device and the at least another IoT device each comprise a device with a plurality of sensors for identifying items, and wherein the at least one IoT device and the at least another IoT device are each configured to utilize a sleep state outside of active communications.

18. The non-transitory computer program product of claim 15, wherein the operations further comprise:
generating, by the computing apparatus, historical data for at least a portion of the plurality of items, the historical data including an average time that the at least the portion of the plurality of items are in stock within the household;
determining, by the computing apparatus and based on the historical data, an expected time at which the first item will not be in stock; and
providing an indication of the expected time to a user.

19. The non-transitory computer program product of claim 15, wherein the operations further comprise:
receiving, by the computing apparatus, electronic advertisement information;
identifying, by the computing apparatus and based on the current inventory, one or more sales and/or one or more coupons from the electronic advertisement information;
generating, by the computing apparatus and based on the current inventory and the one or more sales or coupons, a shopping list for the household; and
transmitting, by the computing apparatus and via at least one wireless connection, the shopping list to a user access device registered for the household.
